(19) United States
(12) Patent Application Publication
(10) Pub. No.: US 2025/0124413 A1
(43) Pub. Date: Apr. 17, 2025

(54) METHOD AND TRANSACTION SYSTEM FOR TRANSMITTING TOKENS IN AN ELECTRONIC TRANSACTION SYSTEM

(71) Applicant: GIESECKE+DEVRIENT ADVANCE52 GMBH, Munchen (DE)

(72) Inventors: Matthias FASCHING, Unterhaching (DE); Klaus ALFERT, St. Augustin (DE)

(21) Appl. No.: 18/689,662

(22) PCT Filed: Jul. 12, 2022
(86) PCT No.: PCT/EP2022/025324

§ 371 Date: Mar. 6, 2024

(30) Foreign Application Priority Data
Sep. 8, 2021 (DE) 10 2021 004 548.3

(51) Int. Cl. G06Q 20/10; G06Q 20/06; G06Q 20/38; H04L 9/32

(52) U.S. Cl. CPC G06Q 20/108; G06Q 20/0655; G06Q 20/3829; H04L 9/3213; H04L 2209/56

(57) ABSTRACT

A method is provided for registering tokens of an electronic transaction system, wherein each token of the transaction system contains at least a token value and a private part of a token-specific key pair as token elements. A token reference register and to a transaction system employs features of the method.

### TECHNICAL FIELD OF THE INVENTION

The invention relates to methods for transmitting tokens, for example electronic coin data records, in an electronic transaction system, for example in an electronic payment system. The invention also relates to a transaction system.

The invention uses a method for transmitting tokens directly between subscriber units.

The invention relates in particular to the transmission of digital currency issued by a central bank (CBDC) as a token.

### TECHNICAL BACKGROUND OF THE INVENTION

Security of transactions and associated transaction data for transmitting monetary amounts means both protection of the confidentiality of the exchanged data and protection of the integrity of the exchanged data as well as protection of the availability of the exchanged data.

Documents DE 10 2009 038 645 A1 and DE 10 2009 034 436 A1 disclose systems for transferring monetary amounts in the form of electronic data records, which prevent payment with duplicates of the data record and provide a high degree of tamper protection, in this case requiring complex structures and laborious encryption and signing operations for the transactions. These are poorly suited to practical use.

WO 2016/200885 A1 describes a method for encrypting an amount transferred by means of a blockchain ledger, wherein the verifiability of the transaction of the amount is maintained. The method involves adding a concealment amount to an input value. An output value is then generated and encrypted. Both the input value and the output value are within a value range, and a sum of any two values within the range does not exceed a threshold value. Complex range checks are assigned to each of the input values and the output value. These range checks are intended to prove that the input value and the output value fall within the assigned range of values. Each public key can be signed with a ring signature, which is based on a public key of a recipient in the transaction. In this method a blockchain technology is required, which must be called after receipt of an electronic coin data record in order to validate the electronic coin data record.

In WO 2020/212 331 A1 and WO 2020/212 337 A1, systems for the direct transmission of electronic coin data records, eMD, in a payment procedure are proposed, in which a decentralized or central monitoring layer is provided to register eMDs and modifications thereof anonymously but securely. Participants in this procedure can verify the authenticity of the coin data records using masked eMDs that are uniquely assigned to an eMD. This procedure is computationally intensive and complex due to the central or decentralized monitoring entity and the necessary masking of the coin data records. Transmitting the eMD here always requires sending a monetary amount and a concealment amount.

### SUMMARY OF THE INVENTION

The object of the invention is to provide a method for transmitting tokens of a transaction system, in which a transaction of the token is secure while still being simpler and less computationally intensive. In particular, a transaction between subscriber units is to be created. This transaction should be anonymous to third parties. The token should be able to be reused immediately after it is received in a subscriber unit, in order to enable a transaction even without a connection to a remote unit, such as a token reference register or a distributed ledger. On the one hand, a received token should be secret from subscriber units not participating in the transaction. Each subscriber unit of the transaction system should be able to verify a received token, in particular, multiple output attempts and attempts to transmit non-existent token values should be able to be detected by a subscriber unit or in the transaction system generally. It should be possible to register a transmission even if a subscriber unit does not have a communication connection to a token reference register.

This object is achieved by the features specified in the independent patent claims. Additional advantageous exemplary embodiments are described in the dependent claims.

In a first aspect, the object is achieved in particular by a method for transmitting tokens in an electronic transaction system. The method comprises the method steps: receiving transmission information from a first subscriber unit in a second subscriber unit; generating a token-specific cryptographic key pair for a token to be transmitted, wherein a public part of the token-specific cryptographic key pair is obtained by applying a one-way cryptographic function to a generated private part of the token-specific key pair, the private part being a token element of the token to be transmitted; sending the generated public part of the token-specific key pair from the second subscriber unit to the first subscriber unit; creating a registration request for a token reference register of the transaction system comprising at least one token reference uniquely assigned to the token to be transmitted as a token reference to be registered, wherein the token reference comprises at least one token value of the token and the generated public part of the token-specific key pair as token reference elements and a token reference assigned to a token of the first subscriber unit as a previously registered token reference; sending a registration confirmation of the token reference register from the first subscriber unit to the second subscriber unit for a successful registration of the token reference to be registered, or the registration request for registering the token reference to be registered in the token reference register.

A transaction system, for example a digital currency system or a digital central bank system, is a system in which at least two, preferably a plurality of subscriber units can exchange (transfer) digital central bank money in the form of tokens directly among one another. The transaction system is thus, for example, a payment transaction system for exchanging monetary amounts in the form of payment tokens.

A token is a data record of a transaction system that can be exchanged directly between subscriber units. When the token reference is registered in the token reference register, the token is deemed to be transmitted and from that point on, a receiving subscriber unit will be in possession of the token value that the token represents. On the token transmission, the token automatically changes ownership. A token—a data record that is transmissible independently of a transaction topology, such as blockchain topologies “Bitcoin,” “Ethereum” or “Neo”—can be transmitted directly between subscriber units without any intermediate units.

In contrast to the embodiment in WO 2020/212 331 A1 and WO 2020/212 337 A1, in this aspect the token is only transmitted indirectly by registering in the token reference register. In this way, it is not necessary to re-register the token after the transmission.

This eliminates the need for both subscriber units to have a communication link to the token reference register.

The transmission information can be information about starting a transaction. The transmission information can be an invitation to settle a monetary claim (purchase price information) by transmitting tokens with the corresponding token value.

The transmission information can be token information.

The transmission information or token information may be a token-transmission declaration of intent to transmit the token to be transmitted from the first subscriber unit to the second subscriber unit. The token information therefore serves to inform the second subscriber unit that a transmission of a token—for example, to settle a monetary claim against the second subscriber unit—is intended to be binding, without the token already being transmitted.

The transmission information or token information can be the token value of the token to be transmitted. Thus, the second subscriber unit learns that the first subscriber unit intends to transmit a token with the corresponding token value. At this time, no token has been transmitted.

In one embodiment of this aspect, the token-specific key pair can be generated in the second subscriber unit. In addition, the token reference can be sent from the second subscriber unit to the first subscriber unit before the registration request is sent. In this case, in response to the token information from the second subscriber unit, a part of the token, in this case the private part of the key pair, is already generated and also a part of the token reference, here the public part of the key pair, is created. The token reference of a token that has not yet been transmitted is provided to the first subscriber unit, so that both subscriber units participating in the transmission know the same part of the token reference.

In this embodiment of the aspect, the registration request can be sent from the first subscriber unit to the token reference register. The registration request contains all the necessary information to register the token reference in the token reference register. From the time of registration, the token is deemed to be transmitted. The token, which comprises the token value and private key part, can be used by the second subscriber unit to carry out further transactions.

In this embodiment of the aspect, a registration confirmation can be sent from the token reference register to the first subscriber unit. This will inform the first subscriber unit of the success of the registration.

In this embodiment of the aspect, the first subscriber unit can forward a registration confirmation to the second subscriber unit after the registration step. From this point on, the token is deemed to have been transmitted, provided that all token elements (token value in particular) are known to the second subscriber unit.

Alternatively, after the registration step—preferably after obtaining the registration confirmation from the token reference register—the first subscriber unit can transmit the token containing the token value and the public part of the token-specific key pair directly to the second subscriber unit (TE2).

In one embodiment of the aspect, the registration request can be sent to the token reference register either from the first subscriber unit or from the second subscriber unit, depending on the presence of a communication link to the token reference register. Preferably, a registration confirmation is sent from the token reference register to the subscriber unit that sends the registration request to the token reference register.

In this case, the first subscriber unit can provide a communication link between the second subscriber unit and the token reference register if the registration request is to be sent from the second subscriber unit to the token reference register, but the second subscriber unit has no communication link to the token reference register. Or, the second subscriber unit can provide a communication link between the first subscriber unit and the token reference register if the registration request is to be sent from the first subscriber unit to the token reference register, but the first subscriber unit has no communication link to the token reference register.

This means it is possible to ensure that each subscriber unit does not necessarily need to have a communication link to the token reference register in order to have a token transmitted and registered. For example, the communication link can be tunneled.

In an alternative embodiment of this aspect, the token-specific key pair can be generated in the first subscriber unit, wherein the token reference is sent from the first subscriber unit to the second subscriber unit before the sending step.

The token information can be received indirectly by transmitting a token with a token value greater than a claimed token value. For example, the first subscriber unit transmits a token with a token value above the claimed (payable) token value. This is detected in the second subscriber unit and the difference between the received token value and the claimed token value is then obtained as token information (token value of the token to be transmitted).

In this alternative embodiment of the aspect, the registration request can be sent from the second subscriber unit to the token reference register, wherein the registration request preferably also comprises the claimed token value and wherein a register confirmation is preferably sent from the token reference register to the second subscriber unit.

After the registration step, preferably after obtaining the registration confirmation, the token comprising the token value and the public part of the token-specific key pair can be deemed to have been transmitted from the second subscriber unit to the first subscriber unit. The registration in the token reference register is therefore sufficient to transmit the token.

This configuration of the aspect can be applied, for example, for the transmission of change in response to a token value that is too large. The token value that is too large is transmitted to the second subscriber unit with a token and the change is only transmitted indirectly as a token reference.

In one embodiment, the token is an electronic coin data record or payment token to exchange monetary amounts between subscriber units. Colloquially, such a payment token is also referred to as a “digital coin” or “electronic coin” and represents cash in electronic form.

Each token in the transaction system is a data record comprising at least two token elements.

A first token element of each token of the transaction system is a token value, for example an asset value, an asset, a commodity and/or a monetary amount.

A second token element of each token in the transaction system is a private part of a token-specific key pair. This private part is a secret in the transaction system and will not be published and must not be used more than once. The generation of the private part must not be predictable. This private part can be a random number. Preferably, the random number is the result of a true random number generator.

The token is formed from the token value (first token element) and the private part. The token is preferably formed by the concatenation of these two token elements. Any other type of combination of these two token elements is not excluded according to the invention and comprises, for example, consecutively appending, insertion into a TLV data structure and/or logical combination.

The token differs from a data record for classical data exchange or data transfer, since, for example, a classical data exchange takes place on the basis of a question-answer principle or an intercommunication between the partners to the data exchange. A token, on the other hand, is unique and unambiguous in the transaction system. The token exists in the context of a security concept that includes, for example, signatures or cryptographic encryption operations. A token contains all the data elements required by a receiving subscriber unit for verification, authentication, and forwarding of the token to another subscriber unit. Intercommunication between the subscriber units that transmit a token is therefore fundamentally unnecessary for a token.

Anyone who owns a token or has unrestricted access to the token with its token elements can exchange (=transmit) this token with another subscriber unit. The ownership of the token with its at least two token elements (token value and private part of the token-specific key pair) is thus equivalent to the ownership of the value that the token represents. Here, the token can also be transmitted indirectly by registering a token reference.

Each token in the transaction system is assigned a token reference. This assignment is biunique, meaning that a token has exactly one token reference assigned to it, and each token reference has exactly one token assigned to it. The token reference is a public data record that is stored in a verifiable manner in a storage unit of the transaction system token reference register for each subscriber unit.

Both the token and the token reference are unique. The biunique assignment enforces a 1-to-1 relationship between the token and the token reference.

Each token reference in the transaction system is a data record containing at least two token reference elements.

A first token reference element of each token reference is the token value of the token uniquely assigned to the token reference. The token value of the token is thus identical to the token value of the assigned token reference. For example, the token value of the token reference is a copy of the token value of the assigned token.

A second token element of each token reference of the transaction system is a public part of the token-specific key pair. This public part of the token reference, together with the private part of the token, forms the token-specific key pair. The public part is obtained by applying a cryptographic function to the private part.

This cryptographic function is a one-way function. This cryptographic function is therefore a mathematical function that is “easily” computable in terms of complexity theory, but “difficult” to practically impossible to reverse. In this case, a one-way function also refers to a function for which there is no known practical inversion that can be performed within a feasible time and with feasible effort. Preferably, a one-way function is used that operates on a group in which the discrete logarithm problem is difficult to solve, such as a cryptographic method analogous to an elliptic curve encryption, ECC for short, from a private key of a corresponding cryptographic method. The inverse function, i.e. the generation of a token (or the part of the electronic coin data record) from a token reference, is very time-consuming.

The (mere) knowledge or possession of a token reference does not entitle the owner to use/transmit/issue the token value (token reference element). This represents a significant difference between the token reference and the token and is a core of the present invention.

After the application of the cryptographic function to the private part of the token-specific key pair, the public part of the token-specific key pair is obtained as the second token reference element.

The token reference is formed from the token value (first token reference element) and the public part. The token is preferably formed by the concatenation of these two token reference elements. Any other type of combination of these two token reference elements is not excluded according to the invention and comprises, for example, consecutively appending, insertion into a TLV data structure and/or logical combination.

A token reference can preferably be generated by an electronic wallet of a subscriber unit. The use of a token reference is not comparable to the use of addresses of subscriber units in a blockchain-based transaction system, since in the token reference register according to the invention no addresses of the subscriber units are used to prevent traceability of the tokens.

The method for registering provides a receiving step to receive a token reference in a token reference register as part of a registration request. For example, the registration request is sent by a subscriber unit of the transaction system.

The token reference register is a unit of the transaction register that stores the token references, thereby registering the associated tokens. This register can be a central database or storage unit. This register can be a decentralized ledger, for example in a blockchain topology. The token reference register can maintain a history of the token references and/or registration requests.

The received registration request is verified by a verification unit in the token reference register. This verifies whether the at least one token reference of the received registration request is already stored in the token reference register.

A token reference is stored only once in the token reference register. Since a token reference of a token exists only once in the transaction system, the verification step can determine whether it has been attempted to issue a token multiple times.

In one embodiment, in the verification step the verification unit of the token reference register also determines whether the token reference in the received registration request can be assigned to a token. To do this, the token reference or a derivative of the token reference or a history of the token reference must be stored in the token reference register, which can be assigned to the token reference of the received registration request.

In one embodiment, the verification step determines whether the received registration request is syntactically correct. This is used to check, for example, whether the registration request is plausible, whether a command type has been correctly specified in the registration request, whether the token that is uniquely assigned to the token reference is actually present (can exist); and/or whether a difference in token values in the registration request matches a command type specified in the registration request.

In one embodiment, the verification step determines whether a signature of the registration request is correct.

In one embodiment, the verification step also determines whether a sum of token values of all token references within the registration request is zero. This is done by adding up the input token values and the output token values of the registration request. For registration requests originating from subscriber units, a sum of all token values of the registration request must be zero. If the sum does not result in zero, an additional token value has been created in the transaction system or a token value from the transaction system was destroyed in an illicit manner. This makes it easier to detect fraud involving non-existent tokens or illicitly generated tokens. Until now, complex range proofs (zero-knowledge-proofs, ZKP) were necessary, which can now be omitted by using this method.

The received token reference is stored in a storage unit of the token reference register. Once stored, the token uniquely assigned to the received token reference is registered in the transaction system. The storing is only performed if it is determined in the verification step that the at least one token reference of the received registration request is not stored in the token reference register.

The basic principle of registering a token is therefore that a received registration request is verified to determine whether the token reference assigned to the token is already known in the token reference register. If the token reference is already known, it will not be stored again. If the token reference is not known, it is entered (stored) in the token reference register to be available for future verification and checking steps in the transaction system.

In one embodiment, the received registration request is signed with the private part of the token-specific key pair in order to check or verify an assignment from the token reference to the token. If the verification in the verification step is successful, i.e. the signature can be verified, then the sender of the registration request must be in possession of the token or have knowledge of the token. This can be used to detect an attempted fraud involving non-existent tokens or illicitly generated tokens.

In one embodiment, the token reference register has a checking unit for checking a sum of token values relating to the received registration request. This checking unit compares the received registration request with a data inventory of the storage unit and checks in particular a total sum of all token values for any change due to the registration request. This allows the validity of the token value to be checked to determine whether a new token value has been generated illicitly. This could also be used to check old registration requests and their success, this registration request history could be used to process duplicate registration requests sent without loading the storage unit of the token reference register.

In one embodiment, the token to be transmitted may have been obtained by a step of splitting a token contained in the first subscriber unit, wherein the following method steps are carried out to split the token contained in the first subscriber unit: splitting the token value of the token contained into a first token subvalue and a second token subvalue, where the sum of the first token subvalue and the second token subvalue corresponds to the token value of the token to be split; receiving the token reference for the token to be transmitted from the second subscriber unit having the generated public part of the token-specific key pair of the token to be transmitted; creating a token reference for a split token in the first subscriber unit having the second token subvalue and a created public part of a token-specific key pair of the second split token; and creating the registration request comprising the token reference of the contained token of the first subscriber unit, the token reference for the token to be transmitted and the token reference for the split token.

The split can be carried out symmetrically, so that the split token values are the same size. The split can be carried out asymmetrically, so that the split token values are of different sizes.

In one embodiment, the token to be transmitted can be obtained by a step of switching a token contained in the first subscriber unit, wherein the following method steps are carried out for switching the token contained in the first subscriber unit: receiving the token reference for the token to be transmitted from the second subscriber unit comprising the generated public part of the token-specific key pair of the token to be transmitted; creating the registration request comprising the token reference of the contained token and the token reference for the token to be transmitted.

The switching of the token is a further modification option. The token references contained in the registration request can be joined together by concatenation. If a token is transmitted from one subscriber unit directly to another subscriber unit, for example, if the monetary amount is to be transmitted as a token value in the course of a payment transaction, the sending subscriber unit can now have the token value re-registered to itself. This registers the switch in the token reference register.

When a token is transmitted between two subscriber units, these two subscriber units have knowledge of the token at the same time. In order to prevent the sending subscriber unit from also using the token in another (third) subscriber unit (so-called multiple issuing of the token), the transmitted token is preferably switched over from the first subscriber unit to the second subscriber unit (“Switch”).

The token value of the token to be switched corresponds to the token value of the token to be transmitted. When switching, a token with the same token value but a new private part is registered in the token reference register.

In a further aspect of the invention, a method for transmitting tokens in an electronic transaction system is provided, having the following method steps: receiving token information for a token to be transmitted from a first subscriber unit in a second subscriber unit; creating a token-specific cryptographic key pair for the token to be transmitted in the second subscriber unit, wherein a public part of the token-specific cryptographic key pair is obtained by applying a one-way cryptographic function to a generated private part of the token-specific key pair, the private part being a token element of the token to be transmitted; sending, to the first subscriber unit, a token reference uniquely assigned to the token to be transmitted, wherein the token reference contains at least one token value of the token and the generated public part of the token-specific key pair as token reference elements; and switching a token contained in the first subscriber unit over to the token to be transmitted or splitting a token contained in the first subscriber unit to obtain the token to be transmitted; sending, from the first subscriber unit to the second subscriber unit, a proof data record containing the associated token reference and a token reference of the token to be switched or split, whereupon the token to be transmitted is deemed to be transmitted from the first subscriber unit to the second subscriber unit.

This aspect also allows only indirect transmission of tokens between subscriber units, and in addition, the transmission is a pure “offline” transaction without a token reference register. This is because in this aspect, no registration takes place in the token reference register and the tokens are nevertheless transmitted indirectly between the subscriber units. For each correspondence in the token reference register, instead of the registration request to the transaction system, only one proof data record is generated by the first subscriber unit and exchanged directly between the two subscriber units. The second subscriber unit (recipient) can verify the existence and lawful possession of the token on the basis of this proof data record and can waive the registration in the token reference register. The structure or format of the proof data record can correspond to the structure or format of the registration request. In this respect, a token can be transmitted with reduced effort (no registration in the register).

The token is deposited in a subscriber unit. The subscriber unit may have a plurality of tokens, for example, the plurality of tokens may be deposited in a data store of the subscriber unit. For example, the data store can be internal, external, or virtual. In one embodiment, on receiving a token, a “Merge” can take place automatically, so that preferably only one (or a specific number of) tokens are stored in the subscriber unit.

Preferably, only one token is present in the subscriber unit, so that immediately before sending a token in the context of a payment transaction a split takes place, and immediately after receiving a token in the context of a payment transaction a merge step takes place.

For example, the subscriber unit can be a mobile device, such as a smartphone, a tablet computer, a computer, a server or a machine. The subscriber unit can be a smart card that is inserted into a terminal device ready for operation.

For example, the data memory is a wallet store of an electronic wallet. The electronic wallet is, for example, a software application stored in executable form on a subscriber unit. The electronic wallet can allow the subscriber unit to participate in the transaction system. Thus, the electronic wallet is able to generate a registration request to register a token in a token reference register. In addition, the electronic wallet can perform modifications (switching, merging, splitting) to a token and generate any registration requests that may be necessary and send them to the token reference register. In addition, the electronic wallet can transmit tokens to another wallet (in another subscriber unit).

The transmission of the token in the transaction system is preferably atomic.

The token reference register therefore has knowledge of token references of tokens of the transaction system and preferably also performs the processing operations or modifications to the token (token history). The transactions with the tokens are not registered in the token reference register and take place directly between subscriber units of the transaction system in a direct transaction layer of the transaction system.

According to the invention, a token reference register for a transaction system is provided, which is configured for carrying out the method steps according to the method described above.

In a further aspect, a transaction system is provided that comprises a plurality of subscriber units, each of which is configured for the direct transmission of tokens according to the methods described above.

The transaction system can comprise a first subscriber unit, configured for sending transmission information for a token to be transmitted to a second subscriber unit. The first subscriber unit or a second subscriber unit is configured for creating a token-specific cryptographic key pair for the token to be transmitted, wherein a public part of the token-specific cryptographic key pair is obtained by applying a one-way cryptographic function to a generated private part of the token-specific key pair, the private part being a token element of the token to be transmitted. The transaction system also comprises a token reference register, which is configured for receiving a registration request sent by the first subscriber unit or the second subscriber unit. The registration request comprises at least one token reference uniquely assigned to the token to be transmitted as a token reference to be registered, wherein the token reference has at least one token value of the token and the generated public part of the token-specific key pair as token reference elements and a token reference assigned to a token of the first subscriber unit as an already registered token reference.

The transaction system may alternatively comprise: a first subscriber unit, configured for sending token information for a token to be transmitted to a second subscriber unit; a second subscriber unit configured for creating a token-specific cryptographic key pair for the token to be transmitted in the second subscriber unit, wherein a public part of the token-specific cryptographic key pair is obtained by applying a one-way cryptographic function to a generated private part of the token-specific key pair, the private part being a token element of the token to be transmitted. The second subscriber unit is also configured to send to the first subscriber unit a token reference that is uniquely assigned to the token to be transmitted, wherein the token reference has at least one token value of the token and the generated public part of the token-specific key pair as token reference elements. The first subscriber unit is further configured to switch a token contained in the first subscriber unit over to the token to be transmitted or the first subscriber unit is further configured to split a token contained in the first subscriber unit to obtain the token to be transmitted. The first subscriber unit is then further configured for sending, to the second subscriber unit, a proof data record containing the assigned token reference and a token reference of the token to be switched or split, whereupon the token to be transmitted is deemed to be transmitted from the first subscriber unit to the second subscriber unit.

The token reference register can be an instance of a central currency system, and each token can be a digital central bank money.

A transaction system may be provided which comprises: a register layer with the token reference register of the type described above for registering token references; and a direct transaction layer having a plurality of subscriber units, configured for the direct exchange of tokens among one another according to the type described above. No transactions would be logged in the register layer, only token references would be stored and modifications to tokens would be stored via appropriately adapted token references for the purpose of verifying the validity of tokens. This ensures the anonymity of the participants in the transaction system. The token reference register provides information on request about the token references that are uniquely assigned to the tokens of the transaction system, for example, in order to prevent multiple issuing of the same token or to verify the authenticity of the token.

The storage unit of the token reference register preferably stores only token references of tokens actually present in the transaction system. As soon as a token is modified and a corresponding (modified) token reference is to be registered, the (old) token references become invalid and (only) the modified token references are stored in the storage unit.

The transaction system can send transaction register data to a transaction register to manage the tokens. The transaction register data comprises in particular a unique transaction identifier, a transaction amount, an identifier of the first subscriber unit, an identifier of the second subscriber unit and the (at least one) token reference of the token in the token reference register.

A digital currency system as the transaction system comprises a plurality of the described subscriber units, the token reference register and optionally a plurality of coin deposit management units and/or a transaction register.

The present solution is particularly advantageous because the high flexibility in the subscriber units can be offered independently of the token reference register and/or the transaction register. In particular, the token reference register, which is already subject to particularly high requirements in a digital currency system, is not slowed down.

A subscriber unit in the present case can be a Secure Element that has secured access to one or more tokens in a token store. For example, the secure element is installed ready for operation in a terminal device. The secure element and/or the terminal device have a special computer program product (electronic wallet), in particular in the form of a secured runtime environment within an operating system of a terminal device, known as a Trusted Execution Environment TEE, stored on a data storage device, for example a mobile device, a machine or an ATM. Alternatively, the secure element is designed, for example, as special hardware, in particular in the form of a secured hardware platform module, known as a Trusted Platform Module TPM, or as an embedded security module eUICC, eSIM. The secure element provides a trusted environment.

### BRIEF DESCRIPTION OF THE DRAWINGS

In the following, the invention and other embodiments and advantages of the invention are explained in more detail with reference to figures, wherein the figures merely describe exemplary embodiments of the invention. Identical components in the figures are labelled with the same reference signs. The figures are not to be regarded as true to scale; rather, individual elements of the figures can be represented in exaggerated size or simplified for better comprehension.

FIG. 1 shows an exemplary embodiment of a transaction system TS;

FIG. 2a shows an overview of commands according to the invention for tokens;

FIG. 2b shows an overview of signed registration requests according to the invention for the commands according to the invention;

FIG. 3 shows an exemplary embodiment of a flowchart of a method according to the invention for transmitting a token on the basis of switching a token;

FIG. 4 shows an exemplary embodiment of a flowchart of a method according to the invention for transmitting a token on the basis of splitting a token;

FIG. 5 shows an exemplary embodiment of a flowchart of a method according to the invention for transmitting a token on the basis of a change transaction;

FIG. 6 shows an exemplary embodiment of a flowchart of a method according to the invention for transmitting a token without registering the token on the basis of switching a token; and

FIG. 7 shows an exemplary embodiment of a flowchart of a method according to the invention for transmitting a token without registering the token on the basis of splitting a token.

### DETAILED DESCRIPTION OF EXEMPLARY EMBODIMENTS

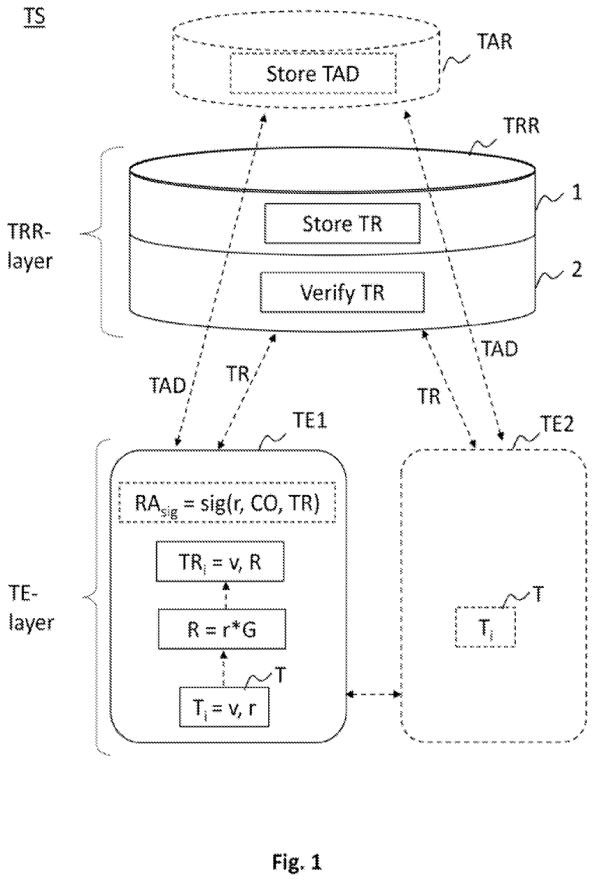

FIG. 1 shows an exemplary embodiment of a transaction system TS. The transaction system TS can be a digital central bank currency system. A token publisher (not illustrated) publishes tokens T as digital coin data records. The token publisher also requests an initial registration of the tokens T in a token reference register TRR of the transaction system TS(=the central bank).

For this purpose, the transaction system TS comprises a register layer TRR-layer, in which a token reference register TRR is arranged. The TS also comprises a direct transaction layer TE-layer, in which a plurality of subscriber units TE can be provided, with two representative subscriber units TE1, TE2 being shown.

The subscriber units TE of the transaction system TS are configured to exchange tokens T directly with one another. In the case of FIG. 1, the tokens are payment tokens, which are also referred to as digital coin. Each token T may have been generated by a token publisher (not shown). Each token T can be split, merged or switched by any subscriber unit TE (not shown) and can be generated and also destroyed by the token publisher TH (not shown). For example, a token publisher TH is a central bank.

An optional transaction register TAR stores transaction data records TAD. A transaction data record TAD will comprise, for example, the transaction amount, a transaction ID, identifiers for TE1 and TE2 and at least the token reference TR of a token T to be transmitted and may have been generated by the subscriber units TE themselves.

A token T is uniquely represented in the transaction system TS by a token value v and a random number r as token elements. The token value v can be specified in a value range from 1 to 2³¹−1. The random number r can be a number in the range from 0 to 2²⁵⁶−1, i.e. the order of an elliptic curve, for example secp256r1.

The random number r is a private part of a token-specific key pair. The random number r is unique in the transaction system TS and secret and must not be published or reused. The generation of the random number r must not be predictable.

For example, the token value v is a 32-bit long token element of type integer. For example, the random number r is a 32-byte long token element of type integer. A subscriber unit TE has exclusive access to this token store or comprises this token store in a data storage unit of the subscriber unit TE.

A token can be stored in a token store as a TLV-encoded data record and then has a unique tag and length information, for example in the following format:

| | Tag | | Token | Random |
|---|---|---|---|---|
| Name | (hex) | Length | value v | number r |
| TLV-encoded toket | 42 | 1 byte | 4 bytes | 32 bytes |

An example of a TLV-encoded token in hexadecimal form is shown below:
42 24 00 00 40 00 00 01 02 03 04 05 06 07 08 09 0A 0B 0C 0D 0E 0F 10 11 12 13 14 15 16 17 18 19 1A 1B 1C 1D 1E 1F and is interpreted as follows:
“42” is the tag identifying the TLV-encoded token T;
“24” indicates the length, in this case that it is a data set of size 36 bytes;
“00 00 40 00” is the token value (integer) v=16384 and therefore has the value € 163.84;
“00 01 02 03 04 05 06 07 08 09 . . . 1D 1E 1F” is the random number r as an integer.

A token reference TR for each token T can be stored in the token reference register TRR. The token reference TR comprises the token value v of the assigned token T and a public part R of the token-specific key pair. The token reference TR of the token T can be viewed at any time in the register TRR of the transaction system TS. The token value v of a token T is thus revealed by the token reference register TRR.

The public part R of the token-specific key pair is generated by applying a cryptographic function to the private part r of the token-specific key pair. This function is difficult to reverse and thus gives the transaction system TS the required security. R=r*G applies, where G can be, for example, a global parameter of the transaction system TS, e.g. a generator point of an elliptic curve, here the secp256r1 curve.

The token reference TR is then formed by the token value v of the token T and the public part R of the key pair. The token reference TR is thus the combination or concatenation of the token value v and public part R.

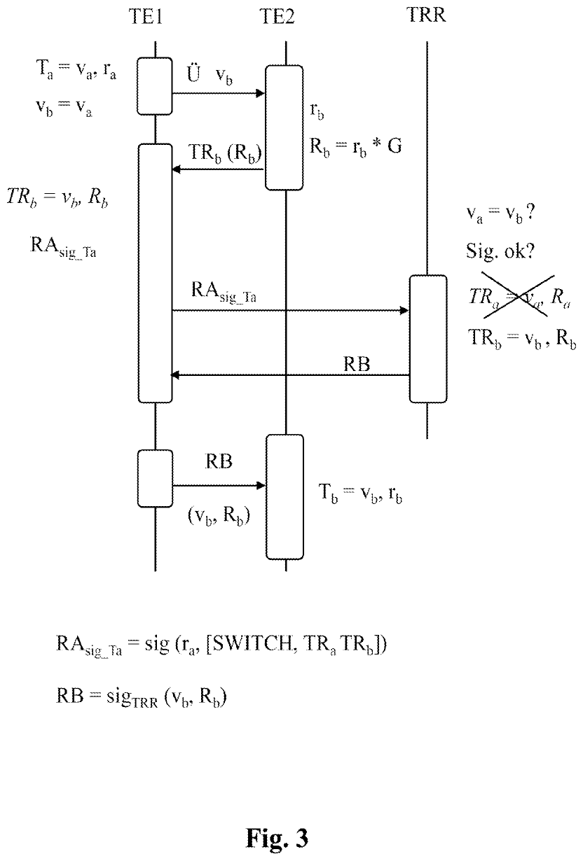

This token reference TR can be sent to the token reference register TRR as registration request RA, possibly together with a command (see overview in FIGS. 3a and 3b) relating to the token T.

In addition, the registration request RA can be signed with the private part r of the token-specific key pair. Signing allows verification of whether the sender of the token reference TR had ownership of the token T, a measure which further increases security in the transaction system TS.

In the subscriber unit TE, the signed registration request RA_{sig} is stored as a so-called proof data record, PR (for proof), for example in the following format:

| Type | Tag (hex) | Length | Data |
|---|---|---|---|
| PR | 4A | N bytes | |

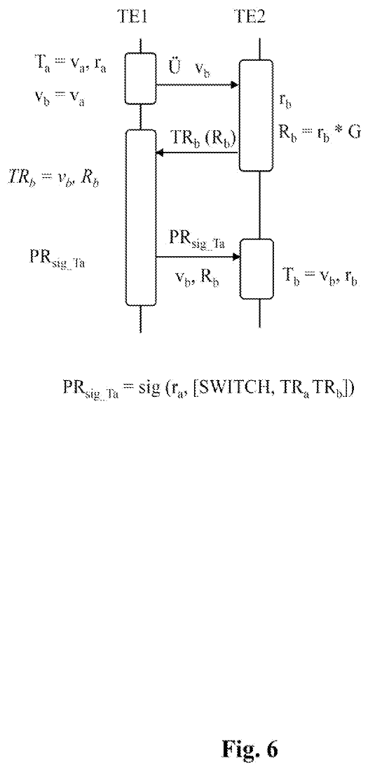

An example of a PR (=RA_{sig}) in hexadecimal form is shown below:
4A 81 8F03 11 12 13 14 15 16 17 18 19 1A 1B 1C 1D 1E 1F 20 21 22 23 24 25 26 27 28 29 2A 2B 2C 2D2E2F30 31 32 33 34 35 36 37 38 39 3A 3B 3C 3D 3E 3F 40 41 42 43 44 45 46 47 48 49 4A4B4C 4D4E4F50 51 52 53 54 55 56 30 46 11 12 13 14 15 16 17 18 19 1A 1B 1C 1D 1E 1F20 21 22 23 24 25 26 27 28 29 2A 2B 2C 2D 2E 2F 30 31 32 33 34 35 36 37 38 39 3A 3B 3C 3D 3E 3F 40 41 42 43 44 45 46 47 48 49 4A4B4C4D4E4F50 51 52 53 54 55 56 and is interpreted as follows (see also FIG. 3 or FIG. 6):
“4A” is the tag used to identify the TLV proof RA_{sig_Th};
“81 8F” indicates the length;
“03” indicates that it is a switch (=SWITCH) registration request;
“11 12 13 14” is the token value vₐ;
“15 16 17 18 19 1A 1B 1C 1D 1E 1F 20 21 22 23 24 25 26 27 28 29 2A 2B 2C 2D 2E 2F 30 31 32 33 34 35” is the public part Rₐ;
“36 37 38 39 3A 3B 3C 3D 3E 3F 40 41 42 43 44 45 46 47 48 49 4A 4B 4C 4D 4E 4F 50 51 52 53 54 55 56” is the public part Rₕ;
“30 46 11 12 13 14 15 16 17 18 19 1A 1B 1C 1D 1E 1F 20 21 22 23 24 25 26 27 28 29 2A 2B 2C 2D 2E 2F30 31 32 33 34 35 36 37 38 39 3A 3B 3C 3D 3E 3F 40 41 42 43 44 45 46 47 48 49 4A4B4C4D4E 4F 50 51 52 53 54 55 56” is the signature as an X690 sequence.

This registration request RA can be sent to the token reference register TRR. This registration request RA is received in the token reference register TRR. After the registration request RA has been checked by the token reference register TRR, the token reference TR is stored in the token reference register TRR, which registers the token T in the transaction system TS.

This token reference TR is uniquely assigned to the token T and is used to register the token T in the transaction system TS. The token reference TR is therefore the public representation of the token T from the direct transaction layer TE-layer. The mere knowledge or possession of the token reference TR does not permit the transmission of the token T and is not equivalent to the TE being in possession of the token T. The token reference TR is used to prevent multiple issue attempts, and checks whether token values v have been generated illicitly. Therefore, the token reference TR and, if applicable, the history of the token T and the corresponding registration requests RA of subscriber units TE are stored in the token reference register TRR.

For example, the tokens T are stored in electronic wallets of a TE. These wallets are, for example, software applications within the TE subscriber units or a terminal device, in which the TE is installed ready for operation. A wallet can be configured as an application on a smartphone, smart card or payment terminal. The wallet is used to securely manage tokens T of the TE, to generate token references TR, modify tokens T and/or exchange tokens T. Wallets are used to communicate with the token reference register TRR, to generate registration requests RA to the token reference register TRR and/or to perform a transaction of tokens T to a subscriber unit TE.

For a transaction with a subscriber unit TE, it is not necessary for a communication connection to the token reference register TRR of the transaction system TS to exist. The transaction system TS is configured to perform a transaction “offline,” i.e. without a communication link to the token reference register TRR. A corresponding registration of tokens T can therefore be ordered after a transmission of the token T to a subscriber unit TE.

The token reference register TRR is a unit of the transaction system TS and is either a central register or a central database of the transaction system TS or a decentralized register or a decentralized database (DLT) of the transaction system TS.

The transmission of a token reference TR from an electronic wallet takes place, for example, as APDU command(s) to a terminal device (smartphone) as a subscriber unit TE. An APDU is a combined command/data block of a connection protocol between the secure element and the terminal device. The structure of the APDU is defined by the ISO-7816-4 standard. The terminal device unpacks APDU command(s) and transmits the data in API calls to the token reference register TRR, where it is converted into HTTP codes.

The token reference register TRR manages, in particular, the storage location for the token references TR, shown here as database 1 as an example of a storage unit in the token reference register TRR. This is represented by the TR for token T of the subscriber unit TE1 being entered in the database 1.

In addition, the token reference register TRR can comprise at least one verification unit 2. The verification unit 2 of the token reference register TRR verifies registration requests RA. The syntactic correctness or the correct specification of a command in the registration request RA can be verified. A history consisting of old (past) registration requests RA regarding a token T can also be verified. The separation of this verification unit 2 from the database 1 distributes the tasks of storing and checking and increases the speed in the token reference register TRR.

In addition, the token reference register TRR can comprise a checking unit (not explicitly shown) that checks whether a total token value E in the transaction system TS is changed with the token value v of a received token reference TR. If this is the case, a new token value v has been created or an existing token value v has been destroyed. Only privileged units, such as a publisher instance TH, are allowed to do this in the transaction system TS. If such a change in the total sum of the token values by a token reference TR of a subscriber unit TE is detected, then a case of fraud can be assumed. Therefore, illegal generation of token values v can be detected and prevented very easily.

Checking the total token value by means of the checking unit represents another security concept in the transaction system TS.

A registration request RA is preferably signed with the private part r. The signature allows the receiver (TRR or TE) to easily check the syntactic authenticity of the command. This check is preferably carried out in the database 1 or the verification unit 2. In addition, a registration request RA can be syntactically validated, for example, by checking the signature and/or the token reference TR.

Even if a signature can be checked in a subscriber unit TE, this does not ensure that multiple issuing of the same token T has not been attempted. Therefore, the facility of registering in the token reference register TRR is provided. In addition, the TE subscriber units maintain a secure hardware platform. With an available connection to the token reference register TRR, the token references TR are transmitted and the multiple-issue attempt can be detected in the token reference register TRR.

If a token reference TR is not yet known in the token reference register TRR, it is added.

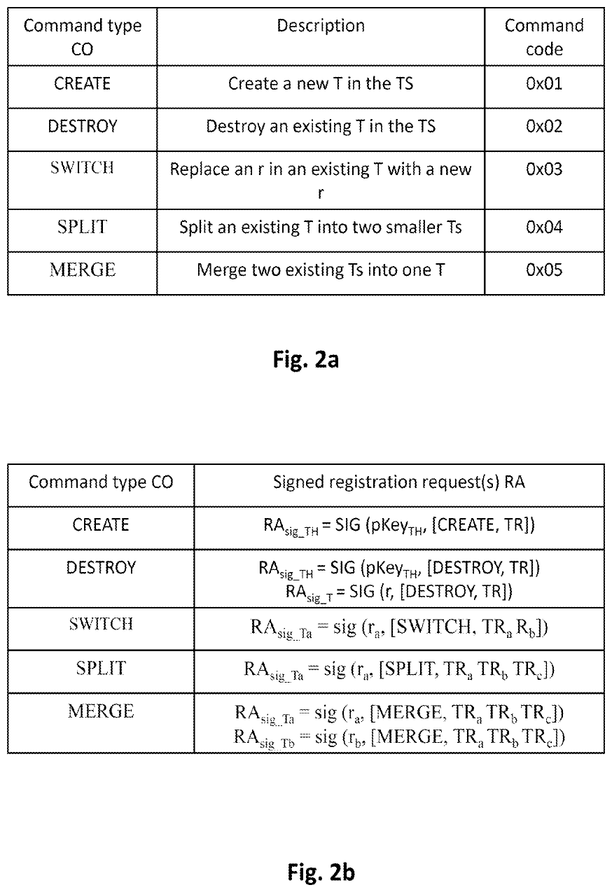

FIG. 2a shows an overview of commands CO that can be performed on a token T. The commands CO can be modifications to an existing token T, for example “Switch”, “Split” or “Merge”. The commands can also relate to the generation (=Create) of a token T or the deletion (Destroy) of existing tokens T. In FIG. 2a, examples of command encodings are given (0x01 to 0x05), which can then be part of a registration request RA.

FIG. 2b shows an overview of commands CO and their signed registration request syntax RA. In these, input tokens T and input token references TR are “consumed” for each command CO. In these, output tokens T and output token references TR are “generated” for each command CO.

A command CO has a basic structure consisting of the following three elements: command type, input token reference(s), output token reference(s).

Note that for the “Split”, “Switch” and “Merge” commands CO, the difference of the token values v of all participating tokens T or token references TR must be equal to zero. In other words, these commands CO “Split”, “Switch” and “Merge” do not generate token values v and do not destroy any token values v. This can be verified from the command type CO itself or by the checking unit of the token reference register TRR and can be a test criterion for a registration request RA.

It should also be noted that a difference in the token values v of the participating token T or token references TR is only allowed for the commands CO “Create” and “Destroy,” but only up to the amount of the token value v of the token T and no further.

Each registration request RA can be signed, to be able to check that the sender of the token reference TR is also in possession of the corresponding token T. An ECDSA schema can be applied as a signature. The registration request RA is preferably signed with the private part r of the token T. For signed registration requests RA_{sig} of the “Create” and “Destroy” command types CO, a further signature of a token publisher may be requested to ensure that these commands have been generated by a privileged unit of the transaction system TS.

FIG. 3 shows an exemplary embodiment of a flowchart of a method according to the invention for transmitting a token T between a TE1 and a TE2 on the basis of a switching command of an existing token Tₐ. The required signed registration request RA_{sig_Ta} and a registration confirmation RB with their command structure are also shown.

A token Tₐ is present in the TE1. The token Tₐ has a token value vₐ and the private part r of the token-specific key pair. The associated token reference TRₐ is registered to the TE1 in the token reference register TRR. A token T_{b} with the token value v_{b} will be transmitted between TE1 and TE2.

To this end, the TE1 sends transmission information U or token information (for example, the token value v_{b} itself) to the TE2. This token information can be a declaration of intent from TE1 to TE2 to transmit the token T_{b}, for example as part of a payment transaction. TE2 then generates a new random number r_{b}, which serves as the private part (the secret) of a new cryptographic token-specific key pair. By applying a one-way cryptographic function (see FIG. 1), the public part R_{b} of the key pair is generated in the TE2.

TE2 then sends the public part R_{b} of the key pair back to TE1. If TE2 is already aware of the token value v_{b} (e.g. the token value to be expected as part of the payment transaction or the token information provided by TE1 is the token value v_{b}), then TE2 can also send the token reference TR_{b} to TE1.

In the TE1, the token Tₐ is now switched to the token T_{b} to be transmitted. A registration request RA_{sigTa} is then created and sent from the TE1 to the TRR. The registration request RA then contains the command “SWITCH” or a corresponding command code according to FIG. 2a, the input token reference TRₐ and the public part R_{b} or the output token reference TR_{b}. This registration request RA is preferably signed with the random number rₐ of the token Tₐ. The signed registration request RA_{sig_ta} is sent from the subscriber unit TE1 to the token reference register TRR. The signature is checked there. In addition, the token value vₐ is compared with the token value v_{b}. If vₐ=v_{b} is true and the signature check is successful, then the token reference TRₐ is deleted or marked as deleted in the token reference register TRR and the token reference TR_{b} is entered in the token reference register TRR. From this point on, the token T_{b} is registered on the TE2.

The success of the registration is indicated to the TE1 by the TRR as registration confirmation RB. The registration confirmation includes the token reference TR_{b}. This registration confirmation may be signed by the TRR to secure the procedure.

The registration confirmation RB can be sent from TE1 to the TE2 to inform TE2 of the success of the registration. Then TE2 can validate the registration confirmation RB once again. This means that the token T_{b} with the token value v_{b} and the private part r_{b} is deemed to be transmitted from TE1 to TE2 without the token needing to be transmitted from TE1 to TE2 with both token elements.

Accordingly, the generated public part R_{b} is transmitted to TE1. TE1 performs the registration by means of a switchover command “SWITCH”. A confirmation RB is returned, if appropriate with the signature of the TRR Sig (v_{b}, R_{b}) for the generated public part R_{b}, and the token value v_{b}. A final switching in the TE2 thus becomes redundant, which means that the procedure is less complex.

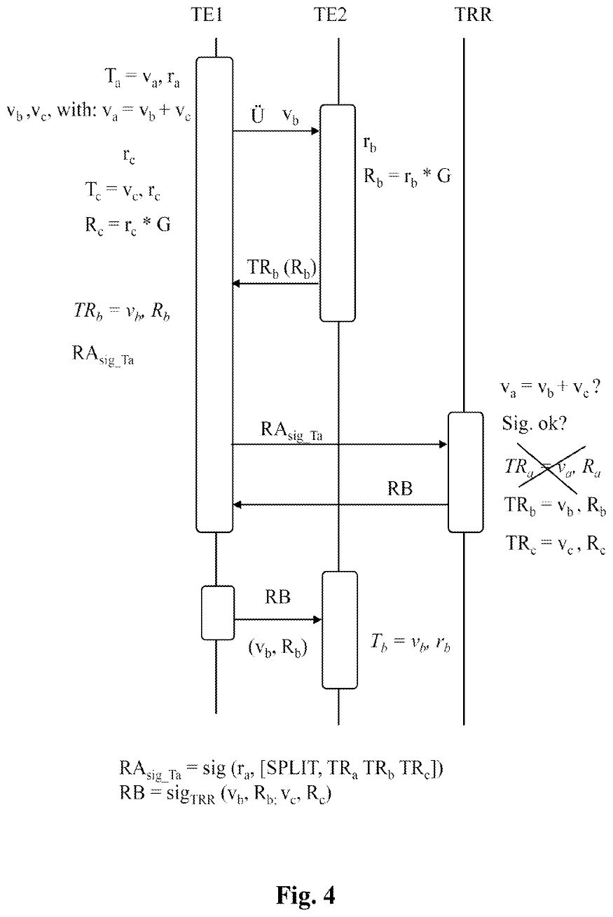

FIG. 4 shows an exemplary embodiment of a flowchart of a method according to the invention for transmitting a token T_{b} on the basis of splitting a token Tₐ. The required signed registration request RA_{sig_Ta} and a registration confirmation RB with their command structure are also shown.

A token Tₐ is present in the TE1. The token Tₐ has a token value vₐ and the private part r of the token-specific key pair. The associated token reference TRₐ is registered to the TE1 in the token reference register TRR. A token T_{b} with the token value v_{b} will be transmitted between TE1 and TE2.

In the TE1, the token value vₐ is split into a first token subvalue v_{b} (token value to be transmitted to TE2) and a further token subvalue v_{c}. The sum of token value v_{b} and token value v_{c} must result in the token value vₐ. This ensures that no new token value v is created or that a token value v is destroyed.

To transmit the token T_{b}, TE1 sends token information (for example, the token value v_{b} itself) to the TE2. This token information is a declaration of intent from TE1 to TE2 to transmit the token T_{b}, for example as part of a payment transaction. TE2 then generates a new random number r_{b}, which serves as the private part (the secret) of a new cryptographic token-specific key pair. By applying a one-way cryptographic function (see FIG. 1), the public part R_{b} of the key pair is generated in the TE2.

TE2 then sends the public part R_{b} of the key pair back to TE1. If TE2 already knows of the token value v_{b} (e.g. the token value to be expected as part of the payment transaction or the token information provided by TE1 is the token value v_{b}), then TE2 can also send the token reference TR_{b} to TE1.

In TE1, in parallel with this or following or prior to it, a new random number r_{c} is generated, which serves as the private part (the secret) of a further cryptographic token-specific key pair. By applying a one-way cryptographic function (see FIG. 1), the public part R_{c} of the key pair is generated in the TE1.

A registration request RA is then created and sent from TE1 to the TRR. The TE1 uses the token references TR_{b} and TR_{c} for this purpose. The registration request RA then contains the command “SPLIT” or the relevant command code shown in FIG. 2a, the input token reference TRₐ and the output token references TR_{b} and TR_{c}. This registration request RA is signed with the random number rₐ of the token Tₐ. The signed registration request RA_{sig_Ta} is sent from TE1 to the token reference register TRR. There, the signature is checked and the sum of v_{b} and v_{c} is formed and compared with the token value vₐ. If vₐ=v_{b}+v_{c} is true and the signature check is successful, then the token reference TRₐ is deleted or marked as deleted in the token reference register TRR and the token references TR_{b} and TR_{c} are entered in the token reference register TRR.

In one embodiment, in the verification unit 2 of the TRR the token value difference of the input token reference TRₐ and the output token references TR_{b} and TR_{c} is formed and it is then checked whether this difference is zero. If the difference is not zero, then a token value v has been illicitly generated or destroyed. In addition, a total token value of the transaction system TS can be checked in the checking unit of the token reference register TRR before or after the registration of the token references TR_{b} and TR_{c}. The total token value in the checking unit must not have changed and must be the same as the value before the registration request was processed in the token reference register TRR.

From this point on, the token T_{b} is registered to the TE2 and the token T_{c} is registered to the TE1.

The success of the registration is indicated to the TE1 by the TRR as registration confirmation RB. The registration confirmation comprises the token references TR_{b} and TR_{c}. This registration confirmation may be signed by the TRR to secure the procedure.

The registration confirmation RB can be sent from the TE1 to the TE2 to inform TE2 of the success of the registration. Then TE2 can validate the registration confirmation RB once again. This means that the token T_{b} with the token value v_{b} and the private part r_{b} is deemed to be transmitted from TE1 to TE2 without the token needing to be transmitted from TE1 to TE2 with both token elements.

Accordingly, here also, only the generated public part R_{b} is transmitted from TE2 to TE1. TE1 performs the registration by means of a split command “SPLIT”. A confirmation RB is returned, if appropriate with the signature of the TRR Sig (v_{b}, R_{b}) for the generated public part R_{b} and the token value v_{b}. A final switching in the TE2 thus becomes redundant, which means that the procedure is less complex.

Not shown in the figures is the additional possibility that an existing token Tₐ is merged with a further token T_{d} in the TE1 and the merged token is registered in the TRR as a token T_{b} to be transmitted.

The random number r_{b} is generated in a TE2 after the token information is obtained. Based on this, a public part R_{b} is then created. The public part R_{b} or the token reference TR_{b} are sent from TE2 to TE1. In TE1, the token values vₐ and v_{d} are summed to form the token value v_{b} based on the input tokens Tₐ and T_{d}. The registration request RA then contains the command “MERGE,” or the command code listed in FIG. 2a, the two input token references TRₐ and TR_{d}, and the output token reference TR_{b}. This registration request RA is signed once with the random number rₐ of the token Tₐ to obtain a first signed registration request RA_{sig_ta}. This registration request is also signed with the random number r_{d} of the token T_{d} in order to obtain a second signed registration request RA_{sig_td}. Both signed registration requests RA_{sig_Ta} and RA_{sig_Ta} are sent from the subscriber unit TE1 to the token reference register TRR. The signatures of the registration requests RA_{sig_Ta} and RA_{sig_Td} are both checked there. Also, the sum of the token values vₐ and v_{d} is formed and compared with the token value v_{b}. If v_{b}=vₐ+v_{d} is true and both signature checks are successful, then TRₐ and TR_{d} are deleted or marked as deleted in the token reference register TRR and the token reference TR_{b} is entered in the token reference register TRR. From this point on, the token T_{b} is registered to the TE2 and the token Tₐ and the token T_{d} of the TE1 are invalid.

The possibility that TE1 does not necessarily have to submit the registration request RA to the TRR is also not illustrated in the figures. Thus, in the absence of a communication link between TE1 and TRR, the TE2 can also establish a communication link to the TRR and forward the communication, for example using a VPN or other tunnel communication.

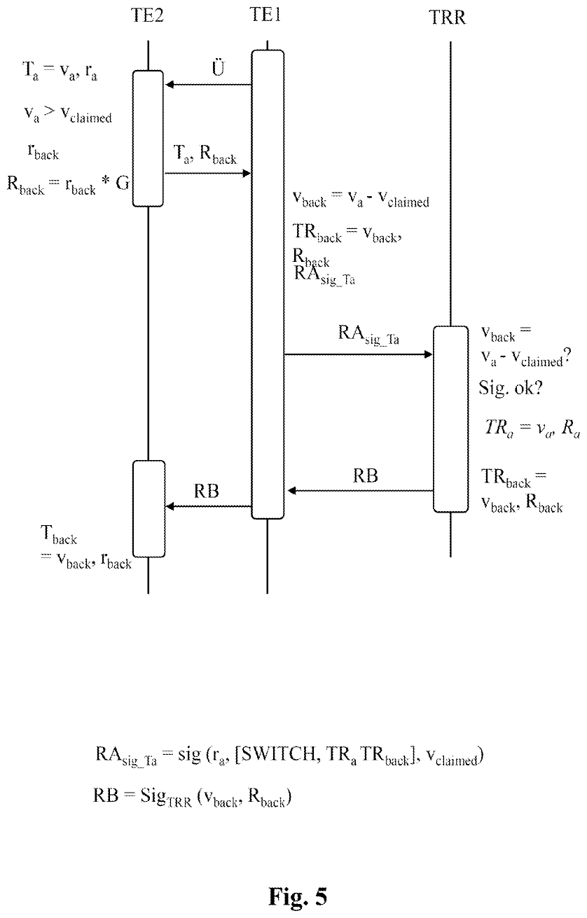

FIG. 5 shows an exemplary embodiment of a flowchart of a method according to the invention for transmitting a token on the basis of a change transaction. In addition, the required signed registration request RA_{sig_Ta} and a registration confirmation RB with their command structure are also shown. The example is explained based on a switching command (according to FIG. 3).

A token Tₐ is present in the TE2. The token Tₐ has a token value vₐ and the private part r of the token-specific key pair. The associated token reference TRₐ is registered to the TE2 in the token reference register TRR. A token T_{claimed} with the token value v_{claimed} will be transmitted between TE2 and TE1. The token value v_{claimed} is less than the token value vₐ.

TE2 then generates a new random number r_{back}, which serves as the private part (the secret) of a new cryptographic token-specific key pair. By applying a one-way cryptographic function (see FIG. 1), the public part R_{back} of the key pair is generated in the TE2.

Instead of splitting the token Tₐ, according to FIG. 5 the token Tₐ and the public part R_{back} are sent back to the TE1.

In the TE1, the amount of a token value v_{back} as money back (change) can be inferred by simple difference formation based on the token value vₐ and with knowledge of the claimed token value v_{claimed} a (as token information). Alternatively, TE2 provides the information about the token value v_{back} directly to TE1.

In TE1, the token reference TR_{back} is then formed by concatenating v_{back} with R_{back}.

A registration request RA_{sigTa} is then created and sent from the TE1 to the TRR. The registration request RA then contains the command “SWITCH” or a corresponding command code according to FIG. 2a, the input token reference TRₐ, the public part R_{b} or the output token reference TR_{b}, and the token value v_{claimed}. This registration request RA is signed with the random number rₐ of the token Tₐ. The signed registration request RA_{sig_Ta} is sent from the subscriber unit TE2 to the token reference register TRR. The signature is checked there. In addition, the token value v_{back} is compared with the sum of vₐ and v_{back}. If v_{back}=vₐ−v_{claimed} is true and the signature check is successful, then the token reference TRₐ is re-registered from TE2 to TE1 in the token reference register TRR and the token reference TR_{back} is entered in the token reference register TRR. From this point on, the token T_{back} is registered to the TE2.

The success of the registration is indicated to the TE1 by the TRR as registration confirmation RB. The registration confirmation includes the token reference TR_{back}. This registration confirmation may be signed by the TRR to secure the procedure.

The registration confirmation RB can be sent from TE1 to the TE2 to inform TE2 of the success of the registration. Then TE2 can then validate the registration confirmation RB once again. This means that the token T_{back} with the token value v_{back} and the private part r_{back} is deemed to be transmitted from TE1 to TE2 without the token T_{back} needing to be transmitted from TE1 to TE2 with both token elements.

Accordingly, the generated public part R_{back} is transmitted to TE1. TE1 performs the registration by means of a switchover command “SWITCH”. A confirmation RB is returned, if appropriate with the signature of the TRR Sig (v_{back}, R_{back}) for the generated public part R_{back} and the token value v_{back}. A final switching in the TE2 thus becomes redundant, which means that the procedure is less complex.

Thus, according to the invention, a combination of payment and money return can be carried out with only one switching command. The change will be (also) registered by TE1 immediately and an additional registration by TE2 can be omitted.

FIG. 6 shows an exemplary embodiment of a flowchart of a method according to the invention for transmitting a token without registering the token, on the basis of switching a token. The method resembles in large parts the method in FIG. 3, hence the description of the identical method steps is omitted. The difference with respect to FIG. 3 is that in FIG. 6 no TRR is required to register the token to be transmitted. Instead of a registration request RA (see FIG. 3), the TE1 generates a proof data record PR (see also FIG. 1 with explanations). The structure and format of the proof data record PR correspond to that of the registration request RA. Thus, the verification of the switch command by the TRR is missing in the flow diagram of FIG. 6, but TE2 no longer needs to carry out a switch command as a transaction system requirement. This reduces the processing involved in the method.

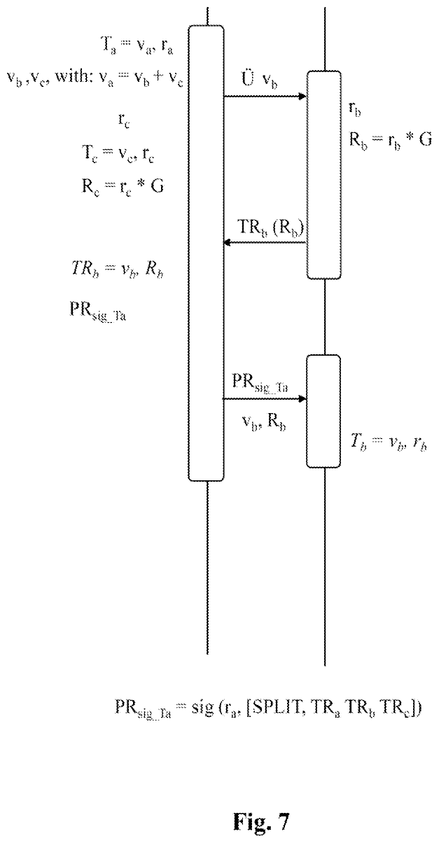

FIG. 7 shows an exemplary embodiment of a flowchart of a method according to the invention for transmitting a token without registering the token on the basis of splitting a token. The method resembles in large parts the method in FIG. 4, hence the description of the identical method steps is omitted. The difference with respect to FIG. 4 is that in FIG. 7 no TRR is required to register the token to be transmitted. Instead of a registration request RA (see FIG. 4), the TE1 generates a proof data record PR (see also FIG. 1 with explanations). The structure and format of the proof data record PR correspond to that of the registration request RA. Thus, the verification of the switch command by the TRR is missing in the flow diagram of FIG. 7, but TE1 no longer needs to carry out a split command as a transaction system requirement. This reduces the processing involved in the method.

1.-16. (canceled)

17. A method for transmitting tokens in an electronic transaction system, comprising the following method steps:
receiving transmission information from a first subscriber unit in a second subscriber unit;
creating a token-specific cryptographic key pair for a token to be transmitted in the second subscriber unit,
wherein a public part of the token-specific cryptographic key pair is obtained by applying a one-way cryptographic function to a generated private part of the token-specific key pair, the private part being a token element of the token to be transmitted;
sending the generated public part of the token-specific key pair from the second subscriber unit to the first subscriber unit;
creating a registration request for a token reference register of the transaction system at least comprising a token reference uniquely assigned to the token to be transmitted as a token reference to be registered, wherein the token reference comprises at least one token value of the token and the generated public part of the token-specific key pair as token reference elements and a token reference assigned to a token of the first subscriber unit as a previously registered token reference; and
sending from the first subscriber unit to the second subscriber unit,
a registration confirmation of the token reference register for the successful registration of the token reference to be registered, or
the registration request to register the token reference to be registered in the token reference register.

18. The method according to claim 17, wherein the transmission information is a token-transmission declaration of intent to transmit the token to be transmitted from the first subscriber unit to the second subscriber unit.

19. The method according to claim 17, wherein the transmission information is the token value of the token to be transmitted.

20. The method according to claim 17, wherein before the sending of the registration confirmation the registration request is sent from the first subscriber unit to the token reference register and
wherein the registration confirmation is sent from the token reference register to the first subscriber unit.

21. The method according to claim 17, wherein the first subscriber unit, after obtaining the registration confirmation, transmits the token comprising the token value and the public part of the token-specific key pair to the second subscriber unit.

22. The method according to claim 17, wherein depending on the presence of a communication link to the token reference register, the registration request is sent to the token reference register either from the first subscriber unit or from the second subscriber unit, and
wherein a registration confirmation is sent from the token reference register to the subscriber unit sending the registration request to the token reference register.

23. The method according to claim 22, wherein the first subscriber unit provides a communication link between the second subscriber unit and the token reference register if the registration request is to be sent from the second subscriber unit to the token reference register, but the second subscriber unit has no communication link to the token reference register; or
wherein the second subscriber unit provides a communication link between the first subscriber unit and the token reference register if the registration request is to be sent from the first subscriber unit to the token reference register, but the first subscriber unit has no communication link to the token reference register.

24. The method according to claim 17, wherein the transmission information is received indirectly by a transmission of the token of the first subscriber unit with a token value greater than a claimed token value.

25. The method according to claim 17, wherein the registration request is sent from the second subscriber unit to the token reference register,
wherein the registration request also comprises the claimed token value and
wherein the registration confirmation is sent from the token reference register to the second subscriber unit.

26. The method according to claim 17, wherein after the registration confirmation has been obtained, the token comprising the token value and the public part of the token-specific key pair is deemed to have been transmitted from the second subscriber unit to the first subscriber unit.

27. The method according to claim 17, wherein for the purpose of registering in the token reference register, it is verified whether the at least one token reference of the received registration request is stored in the token reference register, and storing the at least one token reference in a storage unit of the token reference register for the purpose of registering the token uniquely assigned to this token reference in the transaction system, if it is determined in the verification step that the at least one token reference of the received registration request is not stored in the token reference register.

28. The method according to claim 17, wherein the token to be transmitted is obtained by a splitting step of the token of the first subscriber unit,
wherein in order to split the token of the first subscriber unit the following method steps are carried out:
splitting the token value of the token of the first subscriber unit into a first token subvalue and a second token subvalue, where the sum of the first token subvalue and the second token subvalue corresponds to the token value of the token to be split;
receiving the token reference for the token to be transmitted from the second subscriber unit having the generated public part of the token-specific key pair of the token to be transmitted;
creating a token reference for a split token in the first subscriber unit having the second token subvalue and a created public part of a token-specific key pair of the second split token; and
creating the registration request comprising the token reference of the token of the first subscriber unit, the token reference for the token to be transmitted and the token reference for the split token.

29. The method according to claim 17, wherein the token to be transmitted is obtained by a switching step of the token of the first subscriber unit,
wherein in order to switch the token of the first subscriber unit the following method steps are carried out:
receiving the token reference for the token to be transmitted from the second subscriber unit having the generated public part of the token-specific key pair of the token to be transmitted;
creating the registration request comprising the token reference of the token of the first subscriber unit and the token reference for the token to be transmitted.

30. A transaction system comprising a plurality of subscriber units, each configured for the direct transmission of tokens according to claim 17.

31. The transaction system according to claim 30, comprising:
a first subscriber unit, configured for sending transmission information for a token to be transmitted to a second subscriber unit
the first subscriber unit or a second subscriber unit, configured for creating a token-specific cryptographic key pair for the token to be transmitted, wherein a public part of the token-specific cryptographic key pair is obtained by applying a one-way cryptographic function to a generated private part of the token-specific key pair, the private part being a token element of the token to be transmitted;
a token reference register, configured for receiving, from the first subscriber unit or the second subscriber unit, a registration request comprising at least one token reference uniquely assigned to the token to be transmitted as a token reference to be registered,
wherein the token reference comprises at least one token value of the token and the generated public part of the token-specific key pair as token reference elements and a token reference assigned to a token of the first subscriber unit as a previously registered token reference.

32. The transaction system according to claim 17, wherein the token reference register is an instance of a central currency system and each token is a digital central bank currency.
